(19) United States
(12) Patent Application Publication
(10) Pub. No.: US 2003/0207964 A1
(43) Pub. Date: Nov. 6, 2003

(54) Cleansing device for wc pans

(76) Inventors: Giancarlo Gazzaniga, Salice Terme (IT); Livia Perazzo, Villanova Monferrato (IT); Gian Luca Guenzi, Lomellina (IT)

Correspondence Address: David A Cherry, Woodcock Washburn, One Liberty Place 46th Floor, Philadelphia, PA, 19103, US

(21) Appl. No.: 10/276,213

(22) PCT Filed: May 17, 2001
(86) PCT No.: PCT/IT01/00245

(30) Foreign Application Priority Data
May 19, 2000 (EP) 00830362.0

(51) Int. Cl. C08K 5/05

(52) U.S. Cl. 524/35; 524/387

(57) ABSTRACT

The cleansing device for WC pans comprises a transparent, solid bar (10) and a support member (12) having a lower portion (14) for supporting the bar (10) and an upper projection (16) for engaging the edge of the pan to enable the support member (12) to be suspended.

The present invention relates to a cleansing device for WC pans.

These devices are usually suspended on the edge of the pan so as to dispense cleaning agents, foaming agents, perfumed substances and the like into the pan upon each operation of the flushing system.

A first known type of cleansing device comprises a solid, coloured bar enclosed in a cage which can be suspended on the edge of the pan. The cage renders the bar disposed inside it scarcely visible so as make up for its rather unpleasant appearance. However, the poor visibility of the bar makes it difficult to detect in good time that it has been used up and thus to provide for its replacement.

A second known type of cleansing device comprises a transparent reservoir holding a cleaning substance in the fluid state, the degree of viscosity of which may vary (for example, liquid or gelled). The reservoir has means for dispensing a metered quantity of the substance upon each operation of the flushing system. These latter devices are aesthetically more pleasing than the former devices, displaying fluids which are preferably coloured with bright colours. The visibility of the cleaning substance also allows the consumer to become aware of its progressive consumption and to provide for its renewal in good time. However, these latter devices have the disadvantage of being quite complex from the construction point of view and are therefore decidedly more expensive than the formed devices.

The object of the present invention is to provide a cleansing device which is improved in comparison with those of the prior art and, in particular, which is free of the disadvantages mentioned above.

According to the invention, this object is achieved by means of a cleansing device for WC pans including a transparent, solid bar, this definition being intended to include any bar which at least enables the image of an object to be perceived, even without distinguishing its outlines, by an observer disposed on the opposite side of the bar to the object. Preferably, a support member is associated with the bar and has a lower portion for supporting the bar so as to enable the bar to be seen at least partially from the exterior, and an upper projection for engaging the edge of the pan so as to enable the support member to be suspended. The lower portion of the support member may, for example, be formed as a cage for holding the bar, or as a skeleton for supporting the bar, which at least partially covers the skeleton.

In a preferred embodiment of the invention, the bar is formed by a composition comprising at least:

dibenzylidene sorbitol in a percentage of between 0.5 and

polar solvent having a dissolving power with respect to dibenzylidene sorbitol, in a percentage of between 5 and 90%, and

surfactant in a percentage of between 1 and 60%.

These percentages—and, in the absence of indications to the contrary, also those given in the following part of the present description—should be understood as being by weight and relative to the composition of the bar as a whole. .

In a second preferred embodiment of the invention, the bar is formed by a composition comprising at least:

fatty-acid salt in a percentage of between 2 and 20%,

polar solvent having a dissolving power with respect to fatty-acid salts, in a percentage of between 5 and 40%, and

surfactant in a percentage of between 1 and 60%.

By virtue of the fact that the bar is completely transparent, the device of the invention is aesthetically pleasing. At the same time, the fact that the bar is in the form of a solid block enables it to operate in the same way as a conventional solid bar. In fact, the bar of the invention releases its active components, which can thus perform their function of cleaning the pan, simply as a result of exposure to the water released by the flushing system, without requiring the presence of complex dispensing members.

Preferably, dibenzylidene sorbitol is present in a percentage of between 1 and 5% and the polar solvent which is active with respect thereto is present in a percentage of between 10 and 60%.

The polar solvent is preferably selected from the group consisting of C₁-C₅ glycols, polyalkylene glycols, propylene carbonate, C₂-C₄ alcohols, and mixtures thereof. The polyalkylene glycols are preferably constituted by from 200 to 600 repeating units.

Preferably, the surfactant associated with the dibenzylidene sorbitol is present in a percentage of between 5 and 45% and is selected from the group consisting of anionic, non-ionic and amphoteric surfactants and, in particular, from the group consisting of C₈-C₁₈ alkyl sulphates, sodium alkylbenzenesulphonates, sulphated ethoxylated fatty alcohols, alkylamido-trialkyl oxides and mixtures thereof.

The composition of the first embodiment of the invention may also comprise a modified cellulose, particularly hydroxypropyl cellulose, preferably in a percentage of between 0.2 and 1%. This additive improves the resilience and breaking strength properties of the bar.

With reference to the second above-mentioned embodiment of the invention, the fatty acid is, for example stearic and/or oleic acid and is preferably present in sodium salt form.

Preferably, this salt is present in a percentage of between 5 and 15%, and the solvent active with respect thereto is present in a percentage of between 10 and 30%. The solvent is preferably selected from the group consisting of C₃-C₅ glycols, polyalkylene glycols, poly-alcohols, polysaccharides, propylene carbonate, 2-methyl-1,3-propanediol, C₂-C₄ alcohols and mixtures thereof.

Preferably, the surfactant is present at a concentration of between 5 and 558 and is selected from the group consisting of anionic, non-ionic and amphoteric surfactants and, in particular, from the group consisting of alkali-metal and/or alkaline-earth metal C₈-C₁₈ alkyl sulphates, monoisopropanolamine (MIPA) C₈-C₁₈ alkyl sulphates, triethanolamine C₈-C₁₈ alkyl sulphates, sulphated ethoxylated fatty-alcohols, cocomonoethanolamide and cocodiethanolamide, C₁₀-C₁₈ alkyl betaine, C₁₀-C₁₈ alkylamido-betaine, alkylamido-trialkyl oxides, lauroyl amino-acid derivatives, C₈-C₁₈ alkanesulphonates, C₈-C₁₈ alpha-olefin sulphonates and mixtures thereof.

The composition with the fatty-acid sodium salt, in particular, the sodium salt of stearic acid, may also further contain C₁₄-C₁₈ alcohols and mixtures thereof in a percentage of between 0.2 and 5%. These additives enable the setting times of the bar during production, the appearance, and the transparency of the bar to be adjusted.

The compositions of the second embodiment have been found particularly suitable for achieving adequate foam generation as well as complete dissolution of the bar, even under the effect of comparatively gentle mechanical action such as that exerted by the water flowing over its outer surface.

The various embodiments of the bar of the device of the invention may also comprise all of the ingredients usually used in the field of sanitizing and cleaning products. For example, its composition may comprise perfuming and/or odour-neutralizing substances in a percentage of up to 10% and preferably between 0.1 and 8%.

The composition may also comprise a dye. In general, this has the function of making the bar easily visible and is selected so as to create a logical association between colour and perfume. In particular, with the use of a water-soluble dye, the dye is removed gradually by the water released from time to time by the flushing system. If the quantity of dye is selected in a manner such that its exhaustion coincides with that of the active substances of the bar, the discoloration of the bar acts as an indicator to the consumer of the fact that the device is used up, if the bar is not completely dissolved.

Further advantages and characteristics of the present invention will become clear from the following detailed description, given by way of non-limiting example, with reference to the appended drawings, in which:

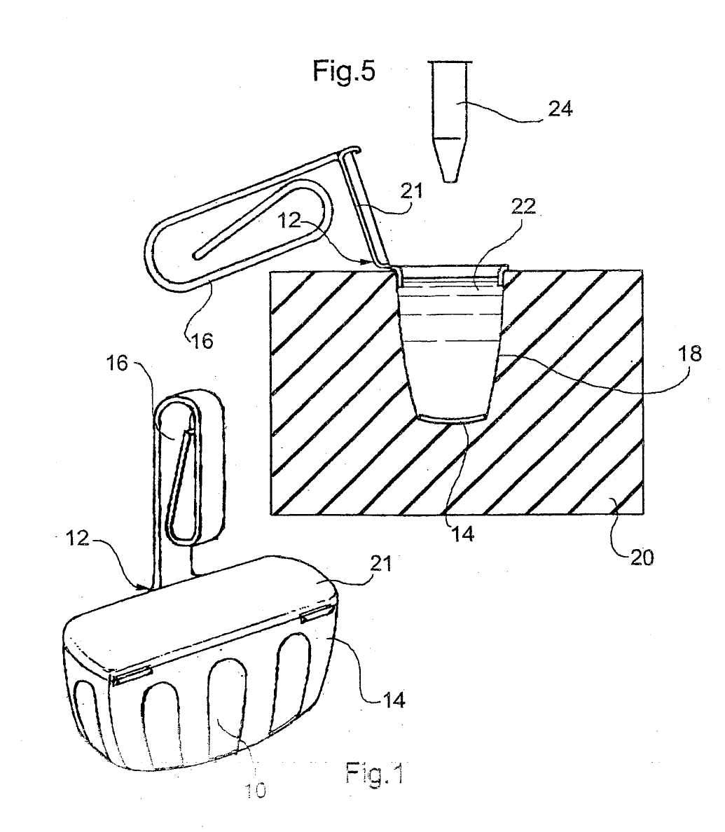

FIG. 1 is a perspective view of a device of the invention,

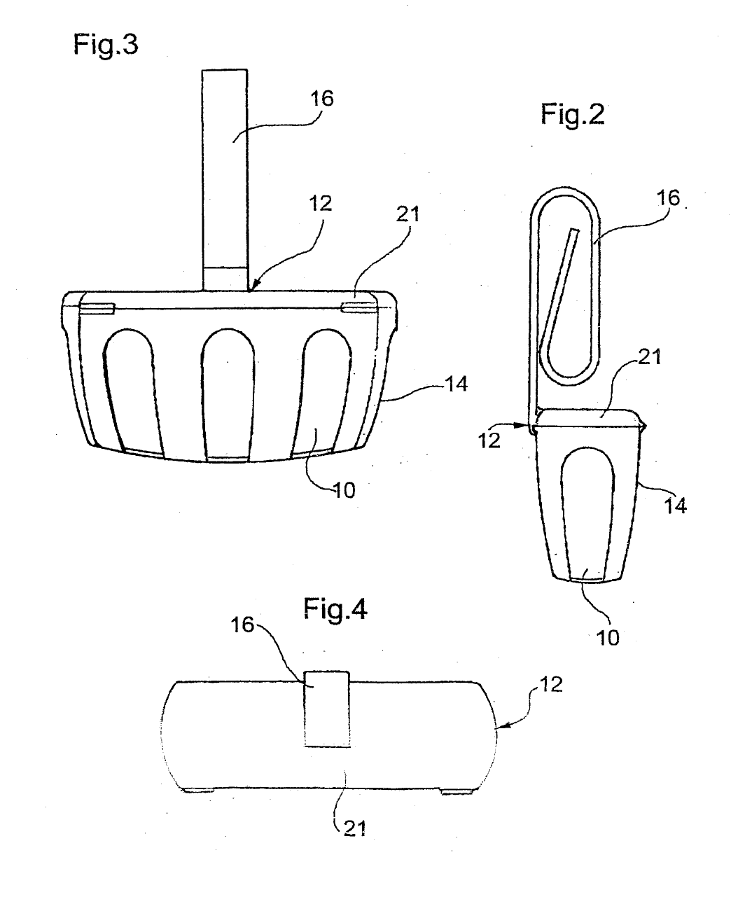

FIG. 2 is a side elevational view of the device of FIG. 1,

FIG. 3 is a front elevational view of the device of FIG. 1,

FIG. 4 is a top plan view of the device of FIG. 1,

FIG. 5 is a schematic representation of a step of a method of producing the device of the preceding drawings,

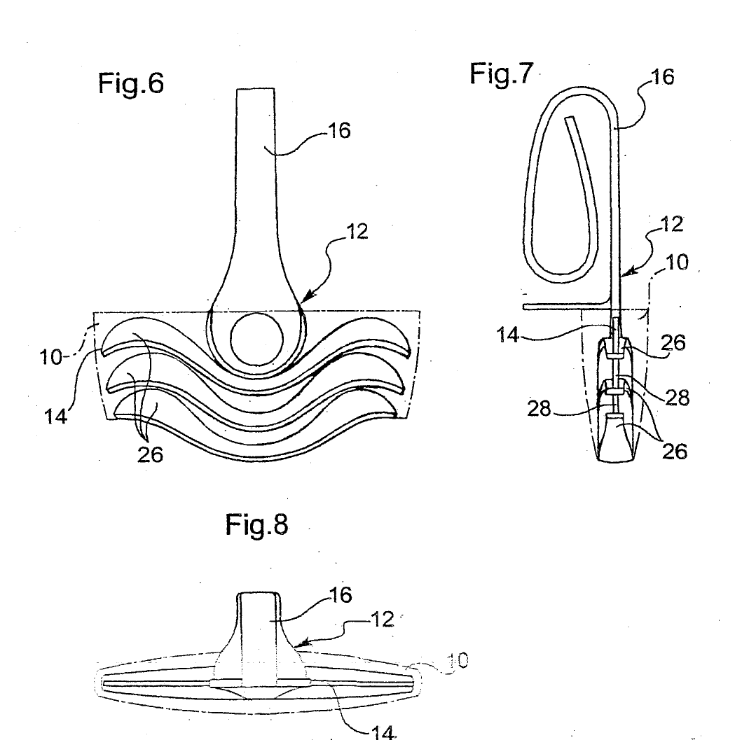

FIG. 6 is a front elevational view of another embodiment of the device according to the invention,

FIG. 7 is a side elevational view of the device of FIG. 6,

FIG. 8 is a top plan view of the device of FIGS. 6 and 7,

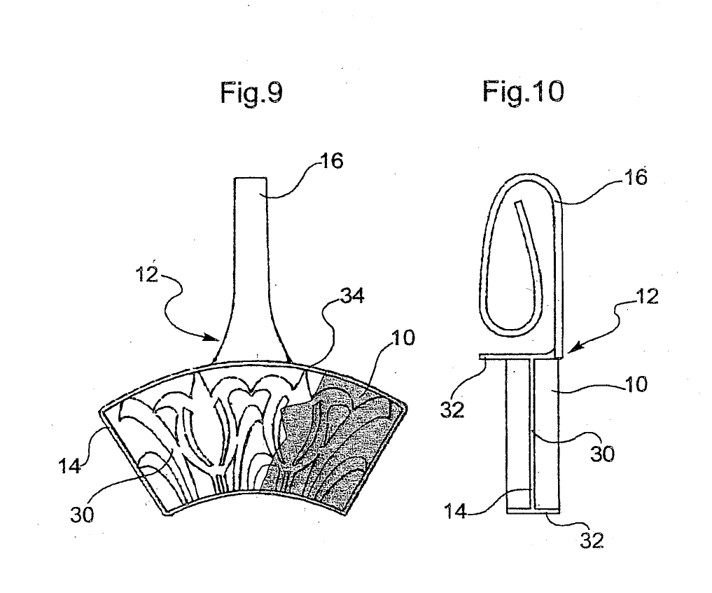

FIG. 9 is a front elevational view of yet a further embodiment of the device according to the invention, and

FIG. 10 is a side elevational view of the device of FIG. 9.

A cleansing device for WC pans comprises (FIGS. 1-4) a completely transparent, solid bar 10 and a support member formed in the manner of a cage 12. The cage has a lower hollow portion 14 for holding the bar 10 and an upper projection 16 for resiliently engaging the edge of the pan to enable the cage to be suspended in a similar manner to conventional devices comprising solid, coloured bars.

A preferred method of producing the device just described provides (FIG. 5), first of all for the lower portion 14 of the cage 12 to be introduced into a cavity 18 of a mould 20, whilst a lid 21 fixed to the projection 16 is kept open. A molten mass 22, four examples of the composition of which are given below, is then poured into the cavity 18 through a nozzle 24.

### EXAMPLE 1

| | | |
|---|---|---|
| propylene glycol | | 40% |
| polyethylene glycol 400 | | 20% |
| hydroxypropyl cellulose | | 1% |
| water | | 7% |
| sodium sulphated ethoxylated fatty alcohol | | 18% |
| dodecylbenzenesulphonic acid | | 7% |
| sodium carbonate (30% solution) | | 3% |
| dibenzylidene sorbitol | | 2% |
| perfume | | 2% |
| dye | complement to | 100% |

### EXAMPLE 2

| | | |
|---|---|---|
| propylene glycol | | 50% |
| hydroxypropyl cellulose | | 1% |
| water | | 18% |
| sodium sulphated ethoxylated fatty alcohol | | 20% |
| C₁₀—C₁₈ alkyl sulphate | | 7% |
| dibenzylidene sorbitol | | 2% |
| perfume | | 2% |
| dye | complement to | 100% |

### EXAMPLE 3

| | | |
|---|---|---|
| propylene glycol | | 11% |
| 2-methyl-1,3-propandiol | | 11% |
| sodium Stearate | | 10% |
| C₁₄ alcohol | | 1% |
| MIPA and sodium alkyl ether sulphate | | 37% |
| C₁₀—C₁₄ propylamido-betaine | | 10% |
| perfume | | 5% |
| cocodiethanolamide | | 10% |
| water | | 5% |
| dye | complement to | 100% |

### EXAMPLE 4

| | | |
|---|---|---|
| propylene glycol | | 10% |
| 2-methyl-1,3-propandiol | | 10% |
| sodium stearate | | 9% |
| C₁₄ alcohol | | 0.5% |
| MIPA and sodium alkyl ether sulphate | | 15.5% |
| C₁₀—C₁₄ propylamido-betaine | | 10% |
| perfume | | 5% |
| cocodiethanolamide | | 8% |
| alkylamido-trialkyl oxides | | 20% |
| sodium alkyl sulphate | | 4% |
| water | | 8% |
| dye | complement to | 100% |

Once the mass 22 has cooled and set, it forms the bar 10. The bar and the cage-like support member 12 thus constitute a single article which can be handled and stored as a unit and which also has a pleasing appearance when displayed at retail points of sale.

The production method just described also ensures that the portions of the bar 10 which will be exposed to the washing action of water in use are defined precisely. These exposed portions in fact correspond to the parts of the bar 10 which are not screened by elements of the cage 12 and which can thus be arranged in accordance with a predetermined optimal arrangement.

It is, however, also possible to form the device of the invention by alternative methods which provide for a molten mass to be poured into a mould of suitable shape to as to produce the bar as an independent article. This is then fitted in a cage produced separately.

FIGS. 6 to 8 show an alternative embodiment of the invention in which numerals identical to those used with reference to the previous drawings indicate the same or equivalent elements.

In this embodiment, the support member 12 comprises a lower portion 14 formed as an internal skeleton for the bar 10. The portion 14 comprises a plurality of appendages 26 spaced apart vertically and connected to one another by connecting elements 28 so as to be able to support the bar 10. The bar, as well as the upper resilient projection 16 of the member 12, have characteristics corresponding to those described above.

The appendages 26 have a horizontally undulating shape so that, together with the bar 10 which covers them, they give the device a pleasing appearance.

The method of producing the device shown in FIGS. 6 to 8 provides for a molten mass having a composition which, once cooled and set, is suitable for forming the bar 10, to be poured into a mould in which the lower portion 14 of the support member 12 has previously been positioned. With reference to the view of FIG. 6, the pouring takes place from above, within the plane of the sheet. Upon completion of the cooling process, the complete device formed by the bar 10 and by the support member 12 fixed firmly together, can be removed from the mould. Alternatively, the molten mass may be poured into the mould first of all, and the lower portion 14 of the support member 12 may then be inserted in the mass before it sets, so as to be incorporated in the bar 10.

FIGS. 9 and 10 show a further alternative embodiment of the invention in which numerals identical to those used with reference to the previous drawings indicate the same or equivalent elements.

In this embodiment also, the support member 12 comprises a lower portion 14 in the form of an internal skeleton for the bar 10. The portion 14 has a central body 30 formed in the manner of a plate which is not necessarily flat, is preferably perforated in accordance with a predetermined design, and joins together transverse end walls 32. The central body 30 as a whole is shaped as an arc of a circular ring. The bar 10, as well as the upper projection 16 of the member 12, have characteristics corresponding to those described above.

The method of producing the device shown in FIGS. 9 and 10 provides for a molten mass having a composition which, once cooled and set, is suitable for forming the bar 10, to be poured into a mould in which the lower portion 14 of the support member 12 has previously been positioned. Upon completion of the cooling process, the complete device, formed by the bar 10 and by the support member 12 fixed firmly together, can be removed from the mould.

With reference to the view of FIG. 9, the pouring takes place in a direction perpendicular to the plane of the sheet and permits considerable versatility of shape. In particular, the edge which is intended, in use, to be the upper edge 34 of the unit constituted by the portion 14 and by the bar 10 may have an arcuate profile. This pouring method allows the thickness of the bar 10 to be decreased, reducing the time required to cool the bar, and shortening the duration of the production process.

Naturally, the principle of the invention remaining the same, the details of construction and forms of embodiment may be varied widely with respect to those described purely by way of example, without thereby departing from its scope. In particular, the term “bar” should not be understood in a restrictive sense as referring exclusively to an element of flat square shape, but is intended to refer to any solid, three-dimensional element, irrespective of its specific shape. The support member in turn may adopt substantially any shape, provided that it enables the bar to be seen from the exterior and at the same time supports it in use, preventing any fragments being scattered into the pan. The support member may also have decorations of any type. It is also possible to vary the above-described production methods by performing a double pouring of molten masses of different compositions and thus producing a bar composed, for example, of portions of different colours.

1. A cleansing device for WC pans, comprising a transparent, solid bar (10).

2. A device according to claim 1, in which the bar (10) is formed by a composition comprising at least:
dibenzylidene sorbitol in a percentage of between 1 and 10%,
polar solvent having a dissolving power with respect to dibenzylidene sorbitol in a percentage of between 5 and 90%, and
surfactant in a percentage of between 1 and 60%.

3. A device according to claim 2, in which the dibenzylidene sorbitol is present in a percentage of between 1 and 5%.

4. A device according to any one of preceding claims 2 and 3, in which the polar solvent is present in a percentage of between 10 and 60%.

5. A device according to any one of preceding claims 2 to 4, in which the polar solvent is selected from the group consisting of C₃-C₅ glycols, polyalkylene glycols, propylene carbonate, C₂-C₄ alcohols, and mixtures thereof.

6. A device according to any one of preceding claims 2 to 5, in which the surfactant is present in a percentage of between 5 and 45% and is selected from the group consisting of anionic, non-ionic and amphoteric surfactants.

7. A device according to any one of preceding claims 2 to 6, in which the surfactant is selected from the group consisting of C₈-C₁₈ alkyl sulphate anionic surfactants, sodium alkylbenzenesulphonates, sulphated ethoxylated fatty alcohols, alkylamido-trialkyl oxides, and mixtures thereof.

8. A device according to any one of preceding claims 2 to 7, in which the composition also comprises a modified cellulose, particularly hydroxypropyl cellulose in a percentage of between 0.2 and 1%.

9. A device according to claim 1 in which the bar (10) is formed by a composition comprising at least:
fatty-acid salt in a percentage of between 2 and 20%,
polar solvent having a dissolving power with respect to fatty-acid salts, in a percentage of between 5 and 40%, and
surfactant in a percentage of between 1 and 60%.

10. A device according to claim 9 in which the fatty acid is stearic acid and/or oleic acid and is present in sodium salt form.

11. A device according to any one of claims 9 and 10 in which the salt is present in a percentage of between 5 and 15% and the polar solvent active with respect to the salt is present in a percentage of between 10 and 30%.

12. A device according to any one of claims 9 to 11 in which the solvent is selected from the group consisting of C₃-C₅ glycols, polyalkylene glycols, poly-alcohols, polysaccharides, propylene carbonate, 2-methyl-1,3-propanediol, C₂-C₄ alcohols and mixtures thereof.

13. A device according to any one of claims 9 to 12 in which the surfactant is present at a concentration of between 5 and 55% and is selected from the group consisting of anionic, non-ionic and amphoteric surfactants and, in particular, from the group consisting of C₈-C₁₈ alkali-metal and/or alkaline-earth metal alkyl sulphates, monoisopropanolamine (MIPA) C₈-C₁₈ alkyl sulphates, triethanolamine C₈-C₁₈ alkyl sulphates, sulphated ethoxylated fatty alcohols, cocomonoethanolamide and cocodiethanolamide, C₁₀-C₁₈ alkyl betaine, C₁₀-C₁₈ alkylamido-betaine, alkylamido-trialkyl oxides, lauroyl amino-acid derivatives, C₈-C₁₈ alkanesulphonates, C₈-C₁₈ alpha-olefin sulphonates and mixtures thereof.

14. A device according to any one of claims 9 to 13 in which the composition also contains C₁₄-C₁₈ alcohols and mixtures thereof in a percentage of between 0.2 and 5%.

15. A device according to any one of preceding claims 2 to 14 in which the composition also comprises perfuming and/or odour-neutralizing substances in a percentage of up to 10% and preferably of between 0.1 and 8%.

16. A device according to any one of preceding claims 2 to 15, in which the composition also comprises a dye.

17. A device according to any one of the preceding, claims, further comprising a support member (12) having a lower portion (14) for supporting the bar (10) and an upper projection (16) for engaging the edge of the pan so as to enable the support member (12) to be suspended.

18. A device according to claim 17 in which the support member is formed as a cage (12) having a hollow lower portion (14) for holding the bar (10) and an upper projection (16) for engaging the edge of the pan so as to enable the cage (12) to be suspended.

19. A device according to claim 17 in which the support member (12) has a lower portion (14) formed as a skeleton for supporting the bar (10), which at least partially covers the skeleton.

20. A device according to claim 19 in which the lower portion (14) of the member (12) comprises a plurality of appendages (26) extending substantially horizontally, spaced apart vertically, and connected to one another by connecting elements (28) so as to be able to support the bar (10).

21. A device according to claim 19 in which the lower portion (14) of the member (12) has a central body (30) formed as a plate which joins together transverse end walls (32).

22. A device according to claim 21 in which the central body (30) is shaped as an arc of a circular ring.

23. A device according to claim 21 or claim 22 in which the central body (30) is shaped as a plate perforated in accordance with a predetermined design.

24. A method of producing a device according to claim 17 which provides for the introduction, into a cavity (18) of a mould (20), first of all of at least the lower portion (14) of the support member (12), and then of a molten mass (22) which is allowed to set so as to form the bar (10) containing its constituent ingredients.

25. A method of producing a device according to claim 18 which provides for the introduction, into a cavity (18) of a mould (20), of a molten mass (22) which is allowed to set so as to form the bar (10) containing its constituent ingredients, and for the subsequent insertion of the bar (10) in the lower portion (14) of the cage (12).
